(19) United States
(12) Patent Application Publication
(10) Pub. No.: US 2026/0154479 A1
(43) Pub. Date: Jun. 4, 2026

(54) METHOD FOR OBTAINING KEY PARAMETERS FOR POLLUTANT TRANSPORTATIONS UNDER COUPLING EFFECTS OF TEMPERATURE AND HYDRODYNAMICS BASED ON SITE

(71) Applicant: HOHAI UNIVERSITY, Jiangsu (CN)

(72) Inventors: Zhou CHEN, Jiangsu (CN); Min JIN, Jiangsu (CN); Jinguo WANG, Jiangsu (CN); Yun YANG, Jiangsu (CN); Zhi DOU, Jiangsu (CN)

(73) Assignee: HOHAI UNIVERSITY, Jiangsu (CN)

(21) Appl. No.: 18/852,506

(22) PCT Filed: Nov. 23, 2023
(86) PCT No.: PCT/CN2023/133502

§ 371 Date: Sep. 30, 2024

(30) Foreign Application Priority Data
Sep. 14, 2023 (CN) 202311184650.1

(51) Int. Cl. E21B 43/00; E21B 47/06; E21B 49/00

(52) U.S. Cl. CPC G06F 30/28; G01N 13/00; G01N 2013/003; G06F 2111/10

(57) ABSTRACT

Disclosed by the present disclosure is a method for obtaining key parameters for pollutant transportations under coupling effects of temperature and hydrodynamics based on a site scale. The method is to obtain the permeability parameters, thermal conductivity, and dispersion coefficient of the contaminated sites based on multi field coupling numerical simulations of hydrodynamic field-temperature field-concentration field. The transportation parameters for pollutants on the site are key indicators for the investigations and treatments of organic pollution on the site. The method as illustrated in the present disclosure includes establishing a water-thermal-salt coupling model for organic contaminated sites according to site drilling data and site physical test results in the early stage, performing multiple field coupling numerical inversion according to the site model in combination with multi-party data, adjusting the model parameters through manual trial and error method to improve model accuracy and obtaining the optimal model.

### TECHNICAL FIELD

The present disclosure relates to a field of obtaining key parameters for pollutant transportations on a site, and particularly relates to a method for obtaining key parameters for pollutant transportations under coupling effects of temperature and hydrodynamics based on a site scale.

### BACKGROUND

During a process of controlling and restoring contaminated sites, acquisitions of various parameters for the aquifers relies on hydrogeological survey works. Geological structures of the aquifers and hydrogeological parameters are determined through various hydrogeological experiments, geophysical explorations, and hydrogeological drilling, which is conducive to making qualitative and quantitative determinations on concentrations, distribution ranges, and transportation characteristics of pollutants.

The seepage field, a dynamic evolution process of the temperature field, and solute transport characteristics of the aquifer are crucial for site managements and evaluations on management effectiveness. The permeability coefficient, the thermal conductivity coefficient, and the dispersion coefficient are important parameters that characterize the characteristics of the seepage field, temperature field, and solute transport in aquifers. These coefficients are also the basic data for groundwater resource calculations and pollution prevention and control. Improving the accuracy of solving the parameters has great significance for the works, such as guiding site managements, restorations. At present, multiple survey methods are used in combination, and multiple physical fields are coupled to obtain the parameters for the aquifer, and these methods have the advantages of high accuracy and low ambiguity.

The relevant research on obtaining important parameters for aquifers through multi field coupled numerical models is relative few, and tests related to multi field coupling of groundwater are mainly conducted at the laboratory scales. From the site scale, there are few field tests in China that simultaneously obtain multiple important parameters for the site through coupling tracing tests. Therefore, by building a site scale water-thermal-salt coupling tracing test platform and conducting on-site tests, in combination with the results of previous pumping tests, micro water tests, and geotechnical tests, multiple field coupling numerical simulations can be implemented to obtain key parameters such as site pollutant permeability, thermal conductivity, and dispersion coefficient.

### SUMMARY

Objectives of the present disclosure: in view of the lack of prior art mentioned above, the objectives of the present disclosure are to provide a coupling simulation method of multi physical fields of water-thermal-salt at a site scale and a system thereof. Firstly, a water-thermal-salt coupling tracing test platform based on the site scale is constructed for three-dimensional multi parameter monitoring (temperature, water pressure, conductivity, and the like) to obtain response signals of hydraulic, temperature, and concentration at a relative low-permeability strata, and three-dimensional long-term series data for hydrodynamic field, temperature field, and concentration field are accumulated, thus the data are taken as the basis for model parameter adjustment.

Technical solutions: in order to realize above objectives, the present disclosure proposes a method for obtaining key parameters for pollutant transportations under coupling effects of temperature and hydrodynamics based on a site scale, and the method includes following specific steps.

In Step 1), a water injection well H1, a pumping well H4, observation wells H0, H2, and H3 are arranged on a contaminated site, pre-experiments are conducted on each of the wells, including geotechnical tests, pumping tests, and micro water tests, and an initial permeability coefficient for an aquifer of the site is obtained, and the initial permeability coefficient is taken as a calibration standard for subsequent models.

In Step 2), on a basis of the pre-experiments, coupling tracing tests including the pumping tests, thermal tracing tests and salt tracing tests are conducted on each of the wells. The pumping tests are to calculate a permeability coefficient by observing water level variations of the aquifer. The thermal tracing tests are to calculate a thermal conductivity coefficient by observing a relation between depth and temperature variations in each of the wells. The salt tracing tests are to convert a conductivity into a concentration calculation dispersion coefficient by observing a relation between the depth and conductivity variations, and probes are arranged according to positions of test wells and observation wells, and a temperature, a conductivity, and a permeability coefficient for aquifers are monitored at different depths.

In Step 3), a three-dimensional groundwater flow field model is constructed, a contaminated site data in an experimental area is processed into spatial coordinates, an initial condition and a boundary condition are set, and the permeability coefficient, the thermal conductivity coefficient, and a dispersion coefficient obtained from on-site experiments are input into a simulation software COMSOL Multiphysics 5.6 for a three-dimensional modeling. The three-dimensional groundwater flow field model is divided into three layers according to the positions of the test wells and the observation wells, to obtain a three-dimensional groundwater flow field model of the contaminated site.

In Step 4), groundwater level data from the observation wells H0, H2, and H3 on contaminated sites are collected, and groundwater level data during the same observation period are obtained in the constructed three-dimensional groundwater flow field model of the contaminated site. Actually, measured water level values are compared with simulated water level values to obtain a root-mean-square error of the groundwater level. Model parameters are adjusted according to the initial permeability coefficient for the aquifer obtained from the pre-experiments, to ensure that the root-mean-square error of the groundwater level is within a preset range.

In Step 5), multi field coupling simulations of a groundwater flow field, a temperature field, and a solute concentration field are conducted by utilizing a corrected three-dimensional groundwater flow field model of the contaminated site. A Darcy's law module in the software COMSOL Multiphysics 5.6 is selected for a groundwater flow field simulation, a porous medium thermal transfer module in the software is selected for a temperature field simulation, and a porous medium dilute matter transfer module in the software is selected for a solute concentration field distribution. Multi physical field simulations of the groundwater flow field and the temperature field, the groundwater flow field and the solute concentration field, as well as the groundwater flow field and the temperature field solute and the concentration field are conducted respectively, and influence relations between each of the fields under a full coupling condition are obtained.

In Step 6), the permeability coefficient, the thermal conductivity coefficient, and the dispersion coefficient in the groundwater flow field model are adjusted and corrected by utilizing monitoring data at different depths in the tracing tests, and an optimal model for the contaminated site is determined.

In Step 7), pollutant transportation parameters are predicted according to the optimal model for the contaminated site, a water level, a temperature, a conductivity or a concentration of the aquifer are input into the optimal model, and the pollutant transportation parameters, that is, the permeability coefficient, the thermal conductivity coefficient, and the dispersion coefficient are obtained.

Further, in Step 1), an experimental area of the contaminated site is a square of 3 m×3 m, the water injection well H1, the pumping well H4, and the observation wells H2 and H3 are located at four corners of the square experimental area, and the observation well H0 is located at a center of the square experimental area.

Further, in Step 1), data for both the pumping tests and the micro water tests are processed by a Theis wiring means, and geological parameters for the aquifer are determined by comparing actually measured curves with theoretical curves.

Further, in Step 2), the probes in each of the wells are a HR8801 water level temperature monitoring recorder and a HR-206A online conductivity sensor, the recorder and the sensor are taken as one group and are connected to an underground measurement and control terminal, the observation wells H0, H2, and H3 are respectively equipped with integrated water level and temperature sensors as well as conductivity sensors at depths of 8.5 m, 9.5 m, 10.5 m, 11.5 m, and 12.5 m; the pumping well is equipped with one group of an integrated water level and temperature sensor as well as a conductivity sensor at a depth of 11.5 m; and the water injection well is equipped with one group of an integrated water level and temperature sensor as well as a conductivity sensor at a depth of 12.5 m.

Further, in Step 3), a plane range of a three-dimensional structural model is in a shape of rectangle, a long axis of the rectangle is parallel to a line connecting the pumping well and the water injection well, the long axis is 18.55 m, a short axis is 10.11 m, and an average vertical height is 18.67 m. The model is divided into three layers according to the positions of the test wells and the observation wells, specifically, a fill layer is generalized from a ground surface to a depth of 4 m, a clay layer is generalized from the depth of 4 m to a depth of 13.5 m, and a bedrock layer is generalized from the depth of 13.5 m to a bottom plane of the model.

Further, in Step 3), the initial condition and the boundary condition of the groundwater flow field model of the contaminated site are set as follows.

A boundary parallel to an artificial groundwater flow field is set as a non-flowing boundary, a top plane and a bottom plane of the model are set as a non-flowing boundary, and two side boundaries perpendicular to a main flow direction of the groundwater are set at the positions of the observation wells and set as a fixed water level boundary, a water level value for the fixed water level boundary is set by an interpolation function; the top plane and the bottom plane of the model are set as thermal insulation boundaries, side planes are set as open boundaries, and the water injection well is set as a line thermal source boundary: a parameter setting for the porous medium dilute matter transfer module is same as those for a thermal conduction module, an initial concentration of a dilute material NaCl in the model is set to 0, the top place and the bottom plane of the model are set as non-flux boundaries, and the side planes are set as open boundaries, the water injection well is set as a linear mass source, and a solute flow rate is controlled by a piecewise function.

Further, in Step 4), in a case where an accuracy of the groundwater flow field model is characterized, a root-mean-square error (RMSE) of the model is calculated, the model parameters that the RMSE satisfies preset conditions are selected, and a calculation formula of RMSE is expressed as follows:

$$RMSE = \sqrt{\frac{1}{n} {\sum }_{i = 1}^{n} {( {C}_{i 0} - {C}_{ie} )}^{2}} , \qquad ( 1 )$$

where Cᵢ₀ denotes a numerical simulation calculation value for the permeability coefficient, or the thermal conductivity coefficient or the dispersion coefficient, Cᵢₑ denotes an actually measured value for the permeability coefficient, or the thermal conductivity coefficient or the dispersion coefficient, and n denotes the number of sampling points.

Further, in Step 5), a mass conservation equation and a Darcy flow velocity equation are adopted to simulate the groundwater flow field under an unstable flow condition of the site, and the energy conservation equation and the Darcy flow velocity equation are expressed as follows:

$$\frac{\partial }{\partial t} ( {ϵ}_{p} ρ ) + ∇ \cdot ( pu ) = {Q}_{m} , \qquad ( 2 )$$

$$u = - \frac{κ}{μ} ( ∇ p + ρ g ) , \qquad ( 3 )$$

where t denotes time, measured in s; ϵₚ denotes a porosity; ρ denotes a liquid density, measured in kg/m³: Qₘ denotes an input quality source, measured in kg/(m³*s); κ denotes a permeability, measured in m²; μ denotes a dynamic viscosity, measured in MPa*s; ∇p denotes pressure difference, in MPa; g denotes a gravity acceleration, measured in m/s²; and u denotes a groundwater velocity, measured in m/s².

Further, in Step 5), an energy conservation equation, a thermal conduction equation, and an effective thermal conductivity calculation formula are adopted to simulate the thermal transfer of the porous medium on the site, and the energy conservation equation, the thermal conduction equation, and the effective thermal conductivity calculation formula are expressed as follows:

$${ρ}_{f} {C}_{p , f} u \cdot ∇ T + ∇ q = Q , \qquad ( 4 )$$

$$q = - {k}_{eff} ∇ T , \qquad ( 5 )$$

$${k}_{eff} = {θ}_{s} {k}_{s} + {ϵ}_{1} {k}_{f} + {k}_{disp} , \qquad ( 6 )$$

where C_{p,f} denotes a fluid thermal capacity at constant pressure, measured in J/(kg*K); ρ_{f} denotes a fluid density, measured in kg/m³; u denotes a groundwater flow velocity, measured in m/s²; T denotes a Kelvin temperature, measured in Kl Q denotes a thermal source term, measured in J; q denotes a thermal flow, measured in W/m²; k_{eff} denotes an effective thermal conductivity, measured in W/(m*K), determined by a solid matrix kₛ, a weighted average of a Fluid thermal conductivity k_{f}, as well as a thermal diffusion coefficient k_{disp}, where θₛ and ϵ₁ denote weights.

Further, in Step 5), a following control equation of the porous medium dilute matter transfer module is selected to conduct a salt transport simulation, and the equation is expressed as follows:

$$\partial ( ρ C ) / \partial t + ∇ \cdot ( ρ Cv ) = ∇ \cdot ( D ∇ C ) + R , \qquad ( 7 )$$

where ρ denotes a liquid density, measured in kg/m³; C denotes a concentration of a dilute substance, measured in mol/m³; t denotes time, measured in s; v denotes a velocity vector of the fluid, measured in m/s; D denotes a diffusion coefficient for the dilute substance, measured in m²/s; R denotes a source term, measured in mol/(s*m³).

The principles of the present disclosure are as follows. The aquifer parameters rely on hydrogeological surveys for acquisition, and a single experimental method or a single physical field cannot explore the relations between multiple parameters, whereas relevant aquifer parameters are obtained through the combination of multiple survey methods and a coupling of multiple physical fields to explore the influence relations between various physical fields, which has the advantages of high accuracy and rapid prediction. In view of the variation situations in hydrodynamic conditions, temperature field, and concentration field involved in the control of contaminated sites, the present disclosure obtains the permeability coefficient, the thermal conductivity coefficient, and the dispersion coefficient of the test sites, by conducting coupling tracing tests at the site scale and conducting multi field coupled numerical simulations.

The beneficial effects are as follows. In comparison with the prior art, the technical solutions of the present disclosure have the following beneficial technical effects.

The present disclosure provides a novel method for obtaining key parameters for pollutant transportations through water-thermal-salt multi field coupling tracing tests and numerical simulations based on site scale. The multi field coupling tests of groundwater is rarely carried out in China to obtain important parameters from the site scale, and the relevant numerical calculations mainly focus on studying the influences of temperature on water distributions, ignoring the transient variations of water distribution field on temperature. The method proposed in the present disclosure implements multi field coupling tracing tests of the groundwater hydrodynamic field, the temperature field, and the concentration field at the site scale to obtain data for each of the fields, more accurately solves the permeability coefficient, the thermal conductivity coefficient, and the dispersion coefficient of the aquifers by adopting the trial and error method in combination with numerical simulations, which has more efficient and accurate application values. The present disclosure provides a novel technical approach for obtaining key parameters for groundwater pollutant transportations during the investigations and remediation process of contaminated sites.

### BRIEF DESCRIPTION OF THE DRAWINGS

In order to clarify the embodiments of the present disclosure or the technical solutions in prior art to be clearer, the following will briefly introduce the accompanying drawings required for the descriptions of the embodiments or the prior art.

FIG. 1 illustrates a schematic diagram of a method for obtaining key parameters for pollutant transportations under coupling effects of temperature and hydrodynamics based on a site scale designed by the present disclosure.

FIG. 2 illustrates a stereoscopic diagram of a three-dimensional conceptual model of a field-scale-based pumping well related to Embodiment 1 provided by the present disclosure.

FIG. 3 illustrates a boundary setting diagram of the three-dimensional conceptual model of the field-scale-based pumping well related to Embodiment 1 provided by the present disclosure.

### DETAILED DESCRIPTION OF THE EMBODIMENTS

The present disclosure will be further clarified in conjunction with the accompanying drawings. The following embodiments are only used to clarify the technical solutions of the present disclosure to be clearer, and cannot be used to limit the protection scope of the present disclosure.

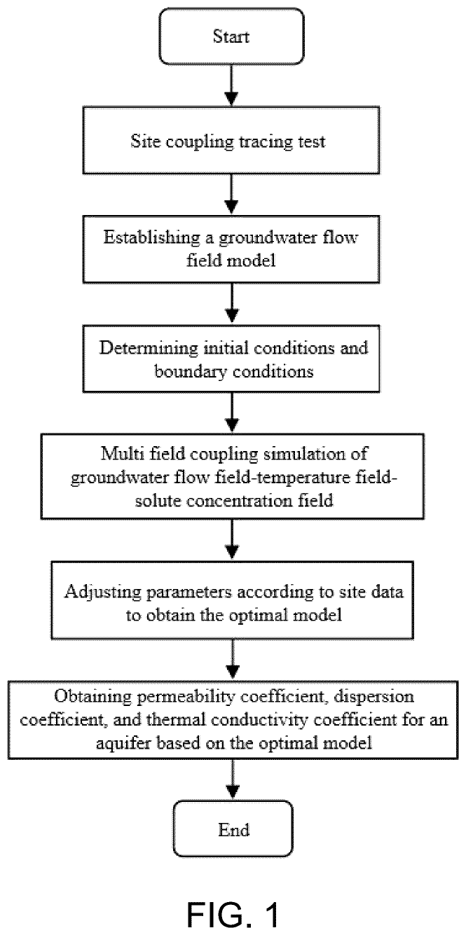

As illustrated in FIG. 1, the present disclosure proposes a method for obtaining key parameters for pollutant transportations under coupling effects of temperature and hydrodynamics based on a site scale, and the method includes following specific steps.

In Step 1), a water injection well H1, a pumping well H4, observation wells H0, H2, and H3 are arranged on a contaminated site, pre-experiments are conducted on each of the wells, including geotechnical tests, pumping tests, and micro water tests, and an initial permeability coefficient for an aquifer of the site is obtained, and the initial permeability coefficient is taken as a calibration standard for subsequent models.

In Step 2), on a basis of the pre-experiments, coupling tracing tests including the pumping tests, thermal tracing tests and salt tracing tests are conducted on each of the wells. The pumping tests are to calculate a permeability coefficient by observing water level variations of the aquifer. The thermal tracing tests are to calculate a thermal conductivity coefficient by observing a relation between depth and temperature variations in each of the wells. The salt tracing tests are to convert a conductivity into a concentration calculation dispersion coefficient is converted by observing a relation between the depth and conductivity variations, and probes are arranged according to positions of test wells and observation wells, and a temperature, a conductivity, and a permeability coefficient for aquifers are monitored at different depths.

In Step 3), a three-dimensional groundwater flow field model is constructed, a contaminated site data in an experimental area is processed into spatial coordinates, an initial condition and a boundary condition are set, and the permeability coefficient, the thermal conductivity coefficient, and a dispersion coefficient obtained from on-site experiments are input into a simulation software COMSOL Multiphysics 5.6 for a three-dimensional modeling. The three-dimensional groundwater flow field model is divided into three layers according to the positions of the test wells and the observation wells, to obtain a three-dimensional groundwater flow field model of the contaminated site.

In Step 4), groundwater level data from the observation wells H0, H2, and H3 on contaminated sites are collected, and groundwater level data during the same observation period are obtained in the constructed three-dimensional groundwater flow field model of the contaminated site are obtained. The actually measured water level values are compared with simulated water level values to obtain a root-mean-square error of the groundwater level. The model parameters are adjusted according to the initial permeability coefficient for the aquifer obtained from the pre-experiments, to ensure that the root-mean-square error of the groundwater level is within a preset range.

In Step 5), multi field coupling simulations of a groundwater flow field, a temperature field, and a solute concentration field are conducted by utilizing a corrected three-dimensional groundwater flow field model of the contaminated site. The Darcy's law module in the software COMSOL Multiphysics 5.6 is selected for a groundwater flow field simulation, a porous medium thermal transfer module in the software is selected for a temperature field simulation, and a porous medium dilute matter transfer module in the software is selected for a solute concentration field distribution. The multi physical field simulations of the groundwater flow field and the temperature field, the groundwater flow field and the solute concentration field, as well as the groundwater flow field and the temperature field solute and the concentration field are conducted respectively, and influence relations between each of the fields under a full coupling condition are obtained.

In Step 6), the permeability coefficient, the thermal conductivity coefficient, and the dispersion coefficient in the groundwater flow field model are adjusted and corrected by utilizing monitoring data at different depths in the tracing tests, and an optimal model for the contaminated site is determined.

In Step 7), pollutant transportation parameters are predicted according to the optimal model for the contaminated site, a water level, a temperature, a conductivity or a concentration of the aquifer are input into the optimal model, and the pollutant transportation parameters, that is, the permeability coefficient, the thermal conductivity coefficient, and the dispersion coefficient are obtained.

Further, in Step 1), an experimental area of the contaminated site is a square of 3 m×3 m, the water injection well H1, the pumping well H4, and the observation wells H2 and H3 are located at four corners of the square experimental area, and the observation well H0 is located at a center of the square experimental area.

Further, in Step 1), data for both the pumping tests and the micro water tests are processed by a Theis wiring means, and geological parameters for the aquifer are determined by comparing actually measured curves with theoretical curves.

Further, in Step 2), the probes in each of the wells are a HR8801 water level temperature monitoring recorder and a HR-206A online conductivity sensor, the recorder and the sensor are taken as one group and are connected to an underground measurement and control terminal, the observation wells H0, H2, and H3 are respectively equipped with water level temperature integrated sensors and conductivity sensors at depths of 8.5 m, 9.5 m, 10.5 m, 11.5 m, and 12.5 m; the pumping well is equipped with one group of an integrated water level and temperature sensor as well as a conductivity sensor at a depth of 11.5 m; and the water injection well is equipped with one group of the integrated water level and temperature sensor as well as the conductivity sensor at a depth of 12.5 m.

Further, in Step 3), a plane range of a three-dimensional structural model is in the shape of rectangle, a long axis of the rectangle is parallel to a line connecting the pumping well and the water injection well, the long axis is 18.55 m, a short axis is 10.11 m, and an average vertical height is 18.67 m. The model is divided into three layers according to the positions of the test wells and the observation wells, specifically, the fill layer is generalized from the ground surface to a depth of 4 m, the clay layer is generalized from the depth of 4 m to a depth of 13.5 m, and the bedrock layer is generalized from the depth of 13.5 m to a bottom plane of the model.

Further, in Step 3), the initial condition and the boundary condition of the groundwater flow field model of the contaminated site are set as follows:

A boundary parallel to an artificial groundwater flow field is set as a non-flowing boundary, a top plane and a bottom plane of the model are set as the non-flowing boundary, and two side boundaries perpendicular to a main flow direction of the groundwater are set at the positions of the observation wells and are set as a fixed water level boundary, a water level value for the fixed water level boundary is set by an interpolation function; the top plane and the bottom plane of the model are set as thermal insulation boundaries, side planes are set as open boundaries, and the water injection well is set as a line thermal source boundary; a parameter setting for the porous medium dilute matter transfer module is same as those for a thermal conduction module, an initial concentration of a dilute material NaCl in the model is set to 0, the top place and the bottom plane of the model are set as non-flux boundaries, and the side planes are set as open boundaries, the water injection well is set as a linear mass source, and a solute flow rate is controlled by a piecewise function.

Further, in Step 4), in a case where an accuracy of the groundwater flow field model is characterized, the root-mean-square error (RMSE) of the model is calculated, the model parameters that the RMSE satisfies preset conditions are selected, and a calculation formula of RMSE is expressed as follows:

$$RMSE = \sqrt{\frac{1}{n} {\sum }_{i = 1}^{n} {( {C}_{i 0} - {C}_{ie} )}^{2}} , \qquad ( 1 )$$

where Cᵢ₀ denotes an numerical simulation calculation value for the permeability coefficient, or the thermal conductivity coefficient or the dispersion coefficient, Cᵢₑ denotes an actually measured value for the permeability coefficient, or the thermal conductivity coefficient or the dispersion coefficient, and n denotes the number of sampling points.

Further, in Step 5), a mass conservation equation and a Darcy flow velocity equation are adopted to simulate the groundwater flow field under an unstable flow condition of the site, and the energy conservation equation and the Darcy flow velocity equation are expressed as follows:

$$\frac{\partial }{\partial t} ( {ϵ}_{p} ρ ) + ∇ \cdot ( pu ) = {Q}_{m} , \qquad ( 2 )$$

$$u = - \frac{κ}{μ} ( ∇ p + ρ g ) , \qquad ( 3 )$$

where t denotes the time, measured in s; ϵₚ denotes a porosity; ρ denotes a liquid density, measured in kg/m³; Qₘ denotes an input quality source, measured in kg/(m³*s); κ denotes a permeability, measured in m²; μ denotes a dynamic viscosity, measured in MPa*s; ∇p denotes pressure difference, in MPa; g denotes a gravity acceleration, measured in m/s²; and u denotes a groundwater velocity, measured in m/s².

Further, in Step 5), an energy conservation equation, a thermal conduction equation, and an effective thermal conductivity calculation formula are adopted to simulate the thermal transfer of the porous medium on the site, and the energy conservation equation, the thermal conduction equation, and the effective thermal conductivity calculation formula are expressed as follows:

$${ρ}_{f} {C}_{p , f} u \cdot ∇ T + ∇ q = Q , \qquad ( 4 )$$

$$q = - {k}_{eff} ∇ T , \qquad ( 5 )$$

$${k}_{eff} = {θ}_{s} {k}_{s} + {ϵ}_{1} {k}_{f} + {k}_{disp} , \qquad ( 6 )$$

where C_{p,f} denotes a fluid thermal capacity at constant pressure, measured in J/(kg*K); ρ_{f} denotes a fluid density, measured in kg/m³; u denotes a groundwater flow velocity, measured in m/s²; T denotes a Kelvin temperature, measured in K; Q denotes a thermal source term, measured in J; q denotes a thermal flow, measured in W/m²; k_{eff} denotes an effective thermal conductivity, measured in W/(m*K), determined by a solid matrix kₛ, a weighted average of a Fluid thermal conductivity k_{f}, as well as a thermal diffusion coefficient k_{disp}, where θₛ and ϵ₁ denote weights.

Further, in Step 5), a following control equation of the porous medium dilute matter transfer module is selected to conduct a salt transport simulation, and the equation is expressed as follows:

$$\partial ( ρ C ) / \partial t + ∇ \cdot ( ρ Cv ) = ∇ \cdot ( D ∇ C ) + R , \qquad ( 7 )$$

where ρ denotes a liquid density, measured in kg/m³; C denotes a concentration of a dilute substance, measured in mol/m³; t denote the time, measured in s; v denotes a velocity vector of the fluid, measured in m/s; D denotes a diffusion coefficient for the dilute substance, measured in m²/s; R denotes a source term, measured in mol/(s*m³).

### Embodiment 1

The present disclosure proposes a method for obtaining key parameters for pollutant transportations under coupling effects of temperature and hydrodynamics based on a site scale, and the constructed site pumping well model is taken as an example in the embodiment of the present disclosure.

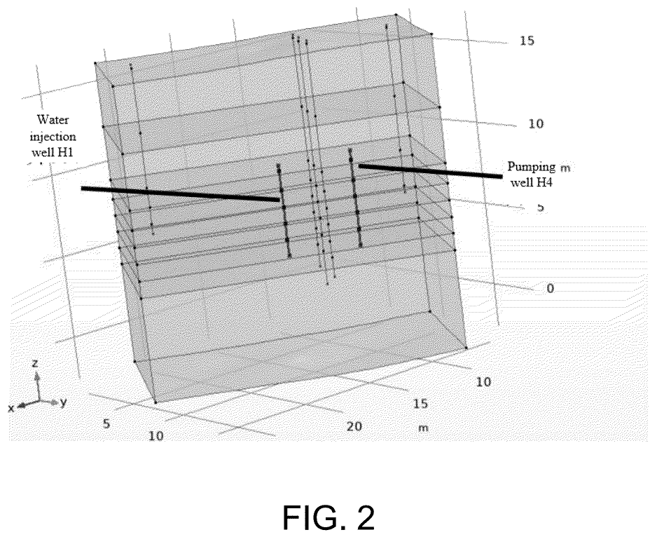

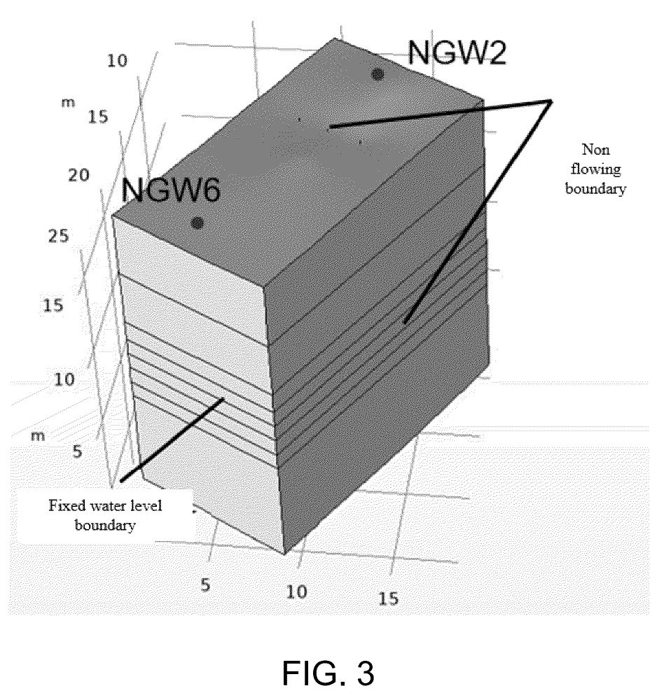

(1) According to the drilling data recorded at the test site, the drilling information texts are established, and a conceptual model of the pumping wells and the water injection wells with the same physical parameters as in actual scenarios is constructed in combination of the pumping tests, the micro water tests, and the geotechnical tests. As illustrated in FIG. 2, the plane range of this three-dimensional structural model is in a shape of rectangle, and the long axis of the rectangle is parallel to the line connecting the pumping wells and the water injection wells, that is, the main flow direction of the groundwater in the artificial flow field. The long axis of the rectangle is 18.55 m, the short axis is 10.11 m, and the average vertical height is 18.67 m. The selection of the model range is determined according to the positions of the test wells and the observation wells. The aquifer is mainly generalized into three layers, a fill layer is generalized from the ground surface to a depth of 4 m, a clay layer is generalized from the depth of 4 m to a depth of 13.5 m, where a depth layer from 8 m to 13 m is subdivided into five fine layers for characterizing the heterogeneity of subsequent test layers. A bedrock layer is generalized from the depth of 13.5 m to a bottom plane of the model. The depth from 8.5 m to 13.5 m are the main test hole sections, which are subdivided into small layers by an interval of 1 m. Considering that the overall gradient of groundwater on the site is relative small, the boundary parallel to the artificial groundwater flow field is set as a non-flowing boundary, and the top plane and the bottom plane of the model are also set as non-flowing boundaries. And considering the distribution of the on-site observation well locations and the longer test period, the water level in the experimental area continuously decreases during the pumping process. Therefore, the two side boundaries perpendicular to the main flow direction of the groundwater are set as fixed water level boundaries, and their water level values are interpolated functions, which are as illustrated in FIG. 3. The parameters related to the groundwater seepage in the model are shown in Table 1.

TABLE 1
Table of relevant parameters for groundwater seepage calculation

| | | Initial | Corrected | | |
|---|---|---|---|---|---|
| | | value for | value for | | |
| Model | | permeability | permeability | Specific | Po- |
| component | | coefficient | coefficient | stor- | ros- |
| name | Strata | (m/s) | (m/s) | age(1/pa) | ity |
| First aquifer | Fill layer | 4.62 × 10−5 | 4.62 × 10−5 | 0.002 | 0.469 |
| Second | Clay layer | 5.53 × 10−6 | 7.22 × 10−6 | 0.0012 | 0.33 |
| aquifer | | | | | |
| Third to | Clay layer | 5.53 × 10−6 | 7.22 × 10−6 | 0.0012 | 0.3 |
| seven | (test | | | | |
| aquifers | section) | | | | |
| Eighth | Bedrock | 5.26 × 10−7 | 5.26 × 10−7 | 0.0008 | 0.13 |
| aquifer | layer | | | | |

(2) The simulations of the groundwater flow field determine the reliability of the model by comparing the simulated water level values for the observation wells H0, H2, and H3 with the actually measured values. In this stage, only the simulations of the groundwater flow field are conducted, without coupling calculation of the multiple fields. The simulations are divided into three groups according to the different time steps and the simulation time periods. Firstly, the groundwater flow field simulation calculation is conducted with a time step of 1 minute and a simulation time period of 2400 minutes to correct the parameters such as the permeability coefficient. Subsequently, the simulation time period is extended to observe the stability of the model, which is shown in Table 2.

(3) Based on the groundwater flow field, combination simulations of different physical fields are conducted to compare the effects between different physical fields under full coupling conditions, and the specific operating conditions are shown in Table 3. The root-mean-square error of the simulation results is generally kept within a relative small range, indicating that the reliability of the model calculation values is relative high, providing a relative good foundation for the subsequent simulation calculation of temperature field and solute concentration field in groundwater flow modeling.

(4) According to the data from different depth sensor probes, the parameters for different strata in the test sections are adjusted through manual trial and error methods to improve the overall accuracy of the model. The simulation time period and step size are mainly determined according to the specific test processes. The fluid properties and solid matrix properties parameters for the thermal transfer module are shown in Table 4.

TABLE 2
Grouping table for groundwater flow field simulations

| Group | Time step (min) | Simulation time period | |
|---|---|---|---|
| First | 1 | 2400 | min |
| Second | 60 | 17.67 | d |
| Third | 60 | 26.33 | d |

TABLE 3
Grouping table for multi field coupled simulations

| | | | Simulation |
|---|---|---|---|
| | | Time step | time period |
| Group | Physical field | (min) | (min) |
| First | Water flow field, | 60 | 17.67 d |
| | temperature field | | |
| Second | Water flow field, | | |
| | solute | 60 | 26.33 d |
| | concentration field | | |
| Third | Water flow field, | | |
| | temperature field, | 60 | 26.33 d |
| | solute | | |
| | concentration field | | |

TABLE 4
Parameters table of porous media thermal transfer module

| | | Longitudinal | Transverse | Vertical | | Thermal capacity |
|---|---|---|---|---|---|---|
| Module | | thermal | thermal | thermal | Dry | at constant |
| Component | | conductivity | conductivity | conductivity | density | pressure |
| Name | Strata | (W/(m*K)) | (W/(m*K)) | (W/(m*K)) | (kg/m³) | (J/(kg*K)) |
| First porous | Fill layer | 2.5 | 0.5 | 0.75 | 1450 | 1050 |
| medium | | | | | | |
| Second porous | Clay layer | 2.2 | 0.3 | 0.75 | 1660 | 1100 |
| medium | | | | | | |
| Third porous | Clay layer | 2.2 | 0.45 | 1.25 | 1700 | 1065 |
| medium | (test section) | | | | | |
| Fourth porous | Bedrock | 2.5 | 0.3 | 0.75 | 1700 | 1300 |
| medium | layer | | | | | |

Through the manual trial and error methods, the permeability coefficient for the fine layer of the aquifer in the test section is adjusted according to the temperature signal variations at different depths of each well, from which it can be observed that during the simulation time period of 2400 minutes, the simulated calculated values for the water level in each test well are closer to the actually measured values, and all the root-mean-square errors are reduced slightly. The water injection well H1 has the largest reduction in root-mean-square error, which is reduced by 0.0383. Next are the water injection well H4 and the observation well H0, which are reduced by 0.0169 and 0.016, respectively. This indicates that the model is finely characterized, which makes the simulation results closer to the true values and is capable of predicting key parameters for the pollutant transportations in the aquifers.

The above is only the preferred embodiments of the present disclosure. It should be pointed out that for ordinary person skilled in the art, a plurality of improvements and variations can be made without departing from the technical principles of the present disclosure. These improvements and variations should also be considered as the protection scope of the present disclosure.

1. A method for obtaining key parameters for pollutant transportations under coupling effects of temperature and hydrodynamics based on a site scale, wherein the method comprises following steps:
1) arranging a water injection well H1, a pumping well H4, observation wells H0, H2, and H3 on a contaminated site, conducting pre-experiments on each of the wells, including geotechnical tests, pumping tests, and micro water tests, and obtaining an initial permeability coefficient for an aquifer of the site, and taking the initial permeability coefficient as a calibration standard for subsequent models;
2) conducting, on a basis of the pre-experiments, coupling tracing tests including the pumping tests, thermal tracing tests and salt tracing tests on each of the wells, wherein the pumping tests are to calculate a permeability coefficient by observing water level variations of the aquifer, the thermal tracing tests are to calculate a thermal conductivity coefficient by observing a relation between depth and temperature variations in each of the wells, and the salt tracing tests are to convert a conductivity into a concentration calculation dispersion coefficient by observing a relation between the depth and conductivity variations, and arrange probes according to positions of test wells and observation wells, and monitoring a temperature, a conductivity, and a permeability coefficient for aquifers at different depths;
3) constructing a three-dimensional groundwater flow field model, processing contaminated site data in an experimental area into spatial coordinates, setting an initial condition and a boundary condition, and inputting the permeability coefficient, the thermal conductivity coefficient, and a dispersion coefficient obtained from on-site experiments into a simulation software COMSOL Multiphysics 5.6 for a three-dimensional modeling, and dividing, according to the positions of the test wells and the observation wells, the three-dimensional groundwater flow field model into three layers to obtain a three-dimensional groundwater flow field model of the contaminated site;
4) collecting groundwater level data from the observation wells H0, H2, and H3 on the contaminated sites, obtaining groundwater level data during a same observation period in the constructed three-dimensional groundwater flow field model of the contaminated site, comparing actually measured water level values with simulated water level values to obtain a root-mean-square error of the groundwater level, and adjusting, according to the initial permeability coefficient for the aquifer obtained from the pre-experiments, model parameters, to ensure that the root-mean-square error of the groundwater level is within a preset range;
5) conducting, by utilizing a corrected three-dimensional groundwater flow field model of the contaminated site, multi field coupling simulations of a groundwater flow field, a temperature field, and a solute concentration field, selecting a Darcy's law module in the software COMSOL Multiphysics 5.6 for a groundwater flow field simulation, selecting a porous medium thermal transfer module in the software for a temperature field simulation, and selecting a porous medium dilute matter transfer module in the software for a solute concentration field distribution, conducting multi physical field simulations of the groundwater flow field and the temperature field, the groundwater flow field and the solute concentration field, as well as the groundwater flow field and the temperature field solute and the concentration field, respectively, and obtaining influence relations between each of the fields under a full coupling condition;
6) adjusting and correcting, by utilizing monitoring data at different depths in the tracing tests, the permeability coefficient, the thermal conductivity coefficient, and the dispersion coefficient in the groundwater flow field model, and determining an optimal model for the contaminated site;
7) predicting, according to the optimal model for the contaminated site, pollutant transportation parameters, inputting a water level, a temperature, a conductivity or a concentration of the aquifer into the optimal model, and obtaining the pollutant transportation parameters, that is, the permeability coefficient, the thermal conductivity coefficient, and the dispersion coefficient.

2. The method for obtaining the key parameters for the pollutant transportations under the coupling effects of the temperature and the hydrodynamics based on the site scale according to claim 1, wherein in Step 1), an experimental area of the contaminated site is a square of 3 m×3 m, the water injection well H1, the pumping well H4, and the observation wells H2 and H3 are located at four corners of the square experimental area, and the observation well H0 is located at a center of the square experimental area.

3. The method for obtaining the key parameters for the pollutant transportations under the coupling effects of the temperature and the hydrodynamics based on the site scale according to claim 1, wherein in Step 1), data for both the pumping tests and the micro water tests are processed by a Theis wiring means, and geological parameters for the aquifer are determined by comparing actually measured curves with theoretical curves.

4. The method for obtaining the key parameters for the pollutant transportations under the coupling effects of the temperature and the hydrodynamics based on the site scale according to claim 1, wherein in Step 2), the probes in each of the wells are a HR8801 water level temperature monitoring recorder and a HR-206A online conductivity sensor, the recorder and the sensor are taken as one group and are connected to an underground measurement and control terminal, the observation wells H0, H2, and H3 are respectively equipped with integrated water level and temperature sensors as well as conductivity sensors at depths of 8.5 m, 9.5 m, 10.5 m, 11.5 m, and 12.5 m; the pumping well is equipped with one group of an integrated water level and temperature sensor as well as a conductivity sensor at a depth of 11.5 m; and the water injection well is equipped with one group of an integrated water level and temperature sensor as well as a conductivity sensor at a depth of 12.5 m.

5. The method for obtaining the key parameters for the pollutant transportations under the coupling effects of the temperature and the hydrodynamics based on the site scale according to claim 1, wherein in Step 3), a plane range of a three-dimensional structural model is in a shape of rectangle, a long axis of the rectangle is parallel to a line connecting the pumping well and the water injection well, the long axis is 18.55 m, a short axis is 10.11 m, and an average vertical height is 18.67 m; the model is divided into three layers according to the positions of the test wells and the observation wells, specifically, a fill layer is generalized from a ground surface to a depth of 4 m, a clay layer is generalized from the depth of 4 m to a depth of 13.5 m, and a bedrock layer is generalized from the depth of 13.5 m to a bottom plane of the model.

6. The method for obtaining the key parameters for the pollutant transportations under the coupling effects of the temperature and the hydrodynamics based on the site scale according to claim 1, wherein in Step 3), the initial condition and the boundary condition of the groundwater flow field model of the contaminated site are set as follows:
a boundary parallel to an artificial groundwater flow field is set as a non-flowing boundary, a top plane and a bottom plane of the model are set as a non-flowing boundary, and two side boundaries perpendicular to a main flow direction of the groundwater are set at the positions of the observation wells and set as a fixed water level boundary, a water level value for the fixed water level boundary is set by an interpolation function; the top plane and the bottom plane of the model are set as thermal insulation boundaries, side planes are set as open boundaries, and the water injection well is set as a line thermal source boundary; a parameter setting for the porous medium dilute matter transfer module is same as those for a thermal conduction module, an initial concentration of a dilute material NaCl in the model is set to 0, the top place and the bottom plane of the model are set as non-flux boundaries, and the side planes are set as open boundaries, the water injection well is set as a linear mass source, and a solute flow rate is controlled by a piecewise function.

7. The method for obtaining the key parameters for the pollutant transportations under the coupling effects of the temperature and the hydrodynamics based on the site scale according to claim 6, wherein in Step 4), in a case where an accuracy of the groundwater flow field model is characterized, a root-mean-square error (RMSE) of the model is calculated, the model parameters that the RMSE satisfy preset conditions are selected, and a calculation formula of RMSE is expressed as:
$$RMSE = \sqrt{\frac{1}{n} {\sum }_{i = 1}^{n} {( {C}_{i 0} - {C}_{ie} )}^{2}} , \qquad ( 1 )$$
where Cᵢ₀ denotes a numerical simulation calculation value for the permeability coefficient, or the thermal conductivity coefficient or the dispersion coefficient, Cᵢₑ denotes an actually measured value for the permeability coefficient, or the thermal conductivity coefficient or the dispersion coefficient, and n denotes a number of sampling points.

8. The method for obtaining the key parameters for the pollutant transportations under the coupling effects of the temperature and the hydrodynamics based on the site scale according to claim 7, wherein in Step 5), a mass conservation equation and a Darcy flow velocity equation are adopted to simulate the groundwater flow field under an unstable flow condition of the site, and the energy conservation equation and the Darcy flow velocity equation are expressed as:
$$\frac{\partial }{\partial t} ( {ϵ}_{p} ρ ) + ∇ \cdot ( pu ) = {Q}_{m} , \qquad ( 2 )$$
$$u = - \frac{κ}{μ} ( ∇ p + ρ g ) , \qquad ( 3 )$$
where t denotes time, measured in s; ϵₚ denotes a porosity; ρ denotes a liquid density, measured in kg/m³; Qₘ denotes an input quality source, measured in kg/(m³*s); κ denotes a permeability, measured in m²; μ denotes a dynamic viscosity, measured in MPa*s; ∇p denotes pressure difference, in MPa; g denotes a gravity acceleration, measured in m/s²; and u denotes a groundwater velocity, measured in m/s².

9. The method for obtaining the key parameters for the pollutant transportations under the coupling effects of the temperature and the hydrodynamics based on the site scale according to claim 8, wherein in Step 5), an energy conservation equation, a thermal conduction equation, and an effective thermal conductivity calculation formula are adopted to simulate the thermal transfer of the porous medium on the site, and the energy conservation equation, the thermal conduction equation, and the effective thermal conductivity calculation formula are expressed as:
$${ρ}_{f} {C}_{p , f} u \cdot ∇ T + ∇ q = Q , \qquad ( 4 )$$
$$q = - {k}_{eff} ∇ T , \qquad ( 5 )$$
$${k}_{eff} = {θ}_{s} {k}_{s} + {ϵ}_{1} {k}_{f} + {k}_{disp} , \qquad ( 6 )$$
where C_{p,f} denotes a fluid thermal capacity at constant pressure, measured in J/(kg*K); ρ_{f} denotes a fluid density, measured in kg/m³; u denotes a groundwater flow velocity, measured in m/s²; T denotes a Kelvin temperature, measured in K; Q denotes a thermal source term, measured in J; q denotes a thermal flow, measured in W/m²; k_{eff} denotes an effective thermal conductivity, measured in W/(m*K), determined by a solid matrix kₛ, a weighted average of a Fluid thermal conductivity k_{f}, as well as a thermal diffusion coefficient k_{disp}, where θₛ and ϵ₁ denote weights.

10. The method for obtaining the key parameters for the pollutant transportations under the coupling effects of the temperature and the hydrodynamics based on the site scale according to claim 1, wherein in Step 5), a following control equation of the porous medium dilute matter transfer module is selected to conduct a salt transport simulation, and the equation is expressed
$$\partial ( ρ C ) / \partial t + ∇ \cdot ( ρ Cv ) = ∇ \cdot ( D ∇ C ) + R , \qquad ( 7 )$$
where ρ denotes a liquid density, measured in kg/m³; C denotes a concentration of a dilute substance, measured in mol/m³; t denotes time, measured in s; v denotes a velocity vector of the fluid, measured in m/s; D denotes a diffusion coefficient for the dilute substance, measured in m²/s; R denotes a source term, measured in mol/(s*m³).
